(19) United States
(12) Patent Application Publication
(10) Pub. No.: US 2011/0123587 A1
(43) Pub. Date: May 26, 2011

(54) Antimicrobial protection for plastic structures

(76) Inventors: Bonnie B. Sandel, Milford, CT (US); Richard H. Dumas, East Haven, CT (US); Patricia A. Turley, Orange, CT (US)

(21) Appl. No.: 12/931,110

(22) Filed: Jan. 25, 2011

Related U.S. Application Data
(62) Division of application No. 10/722,928, filed on Nov. 26, 2003, now abandoned.

(51) Int. Cl. A01N 25/08; A01N 43/40; A01N 55/02; A01P 1/00

(52) U.S. Cl. 424/409; 514/345; 514/188

(57) ABSTRACT

Disclosed is a composition and method for providing antimicrobial protection to plastic structures, such as plastic decking, planking, fencing, and panels. The method comprises applying a water-soluble biocide to the metal-containing structure, and converting the soluble biocide to a water-insoluble metal biocide salt that is adsorbed on the surface of, or into the porous structure of the plastic material. The slow release of the insoluble antimicrobial agent from the surface or from within the pores of said plastic structure provides antimicrobial protection for the plastic structure.

### FIELD OF THE INVENTION

The present invention relates generally to a composition and method for providing antimicrobial protection to extruded or molded plastic structures, such as plastic decking, planking and rails, and fiber reinforced panels. The method comprises applying one or more water-soluble biocides such as the sodium and potassium salts of pyrithione, 2-hydroxypyridine N-oxide, 8-hydroxyquinoline, N-nitroso-N-cyclohexyl hydroxylamine, thiocarbamates and dithiocarbamates to a metal-containing structure, and converting the soluble biocide to a water-insoluble biocide salt or complex that is adsorbed on the surface of, or in the pores of the structure.

### BACKGROUND OF THE INVENTION

In recent years, there has been a rapid development in the use of plastic and plastic composites as wood substitutes for a wide variety of building products applications. For example, mixtures of cellulosic materials (e.g., wood flour) and polymers such as polyethylene, polypropylene, polyallomer, polyacetal, polyamide, polystyrene, polyvinyl chloride, acrylonitrile-butadiene-styrene, and polyurethane when extruded provide a good alternative to lumber for decking, railings, fascia, and other building products uses. In addition to the plastic resin and optional cellulosic material, the plastic-forming composition typically contains optional additives, such as fillers and lubricants. Many of the fillers, pigments, and lubricant additives, as well as other functional additives, contain metals such as calcium, zinc, iron, copper, silver, titanium, manganese or a combination thereof. Wood flour/plastics composites typically provide good durability, and other attractive features such as low maintenance, because the wood flour component is enclosed in a water-resistant plastic material, thereby decreasing the tendency of the wood component to rot. While the tendency to rot and lose structural strength is greatly reduced relative to untreated lumber, there is still a tendency for dark spots to appear due to microbial growth (e.g., fungi or algae) on the surface of the composite structure.

Illustratively, U.S. Pat. No. 5,866,264 discloses extruded synthetic wood made from a cellulosic fibrous-polymer composite material.

As another illustration, fiber reinforced plastic (FRP) is widely used in numerous consumer products to provide a sturdy plastic structure having a desirable surface appearance. For example, FRP is incorporated into bathtubs, sinks and wash basins which are used in homes, hotels, hospitals, restaurants and other residential or commercial environments where such products are continuously exposed to water and a variety of chemicals. In another example, FRP is incorporated into the panels used in automobiles and recreation vehicles as well as into the hulls, decks and interiors of marine vessels, such as commercial and recreational fishing boats. FRP may be made with a polyester resin such as polymethacrylate or polyacrylate to provide a composite material having tensile strength, impact strength, heat resistance, chemical resistance and a high quality surface finish. These are desirable physical and mechanical characteristics, making these products suitable for use in a wide variety of environments.

Irrespective of the application, the surfaces of these plastic products are typically exposed during fabrication, storage, distribution, and use to bacteria, fungi and microbes existing in the environment. Certain uses, such as tubs and sinks for bathrooms, kitchens, hospitals and the like, are particularly associated with pathogen development and proliferation. The presence of humidity or moisture in the environment is conducive to the growth and proliferation of pathogens. Likewise, use of these plastic products in marine application, such as boats, provides exposure to salt water and fresh water environments, which are havens for algae, as well as aquatic thriving pathogens, including algal, fungal and bacterial growth. These bacteria, fungi and other pathogens can grow and multiply on the surfaces of the plastic products, and significant levels of microbial contamination can build over time.

Heretofore, methodologies for incorporating an antimicrobial into plastics and plastic composites typically involved blending it into the plastics precursor prior to extrusion to provide the antimicrobial-containing plastic. Using this methodology, an antimicrobial such as an isothiazolinone, triclosan, 10,10′-oxybisphenoxyarsine, a silver compound, zinc borate, or zinc pyrithione, is mixed with resin, or a combination of resin and wood flour, and extruded. Since the bulk of the plastic-forming composition is treated using this method, it consumes relatively large amounts of antimicrobial material, even though only the surface of the plastic product is normally attacked by fungi. In cases where 10% or more of biocide is employed based upon the weight of the plastic-forming composition, surface imperfections may result, and at higher concentrations, the dimensional strength of the product may be adversely affected. Furthermore, exposure of organic antimicrobials to elevated temperatures in the extruder (typically for a time period of from 1 to 5 minutes) adds a heat history to the antimicrobial that can cause discoloration, decomposition and loss of efficacy.

As an alternative to extrusion, some plastic products are suitably produced by molding. U.S. Pat. No. 5,919,554 discloses a multi-step method for forming polyester-containing FRP composites having a polyester composition comprising the following steps: (a) selecting an antimicrobial agent and a solubilizing agent carrier system compatible with the polyester resin composition, (b) combining the solubilizing agent with the selected antimicrobial agent (c) incorporating the antimicrobial agent into the polyester resin composition, (d) depositing the polyester resin and high modulus fibers into a mold, and (e) curing the polyester resin containing high modulus fibers. The antimicrobial agent, which is a chlorinated phenol, is thusly incorporated into the polymeric material comprising the FRP composite. The resulting composite structure is said to exhibit controlled migration through the polymeric material and to the surface of the FRP composite. One disadvantage of the use of a solubilizing agent for the antimicrobial is the need for subsequent removal of the solvent, as well as the extra process stream, and the environmental risk and expense associated with solvent disposal.

Yet another method of antimicrobial treatment of plastics is disclosed in U.S. Pat. No. 6,149,927. The '927 patent discloses a solid composition comprising zirconium hydroxide and a biocidal compound, such as sodium pyrithione or zinc pyrithione, wherein the solid composition is said to provide controlled release of the biocidal compound once the composition is added to a locus to be protected. Unfortunately, such solid compositions must be incorporated into the bulk material that requires antimicrobial protection or added to a paint or other coating which then is applied to a surface. In the former case, the organic biocide is still subject to thermal decomposition during extrusion or molding. In the latter case, an antimicrobial coating must be formulated and applied to the fabricated plastic surface. A further disadvantage is that the surface may require preparation before the antimicrobial coating can be applied.

There is a need in the plastics industry for a method for incorporating an antimicrobial composition onto the surface and into the porous structures of plastic products, without adding the biocide to the plastic precursor or applying a formulated coating containing an antimicrobial composition. Once incorporated onto the surface and into the porous structures of the plastic product, the antimicrobial should exhibit a controlled release and sufficient efficacy to protect the product following extrusion or molding and during storage, distribution, and use of the product. The present invention provides one answer to those needs.

### SUMMARY OF THE INVENTION

In one aspect, the present invention relates to a process for incorporating an insoluble metal salt or complex of a biocide onto the surface, or into the porous structure of an extruded plastic product which comprises the steps of:
(a) extruding a metal-containing plastic-forming composition in an extruder at an elevated temperature to provide a metal-containing extruded product,
(b) contacting the extruded (advantageously freshly extruded) product with an aqueous solution of a water-soluble biocide in order to cause the water soluble biocide to react or chelate with at least a portion of the metal in the warm product, thereby forming an antimicrobially protected plastic product having a water-insoluble metal salt or complex of biocide in the porous structure or on a surface thereof. Examples of water-soluble biocides forming insoluble metal salts are dipyrithione magnesium sulfate, sodium and potassium salts of pyrithione, 2-hydroxypyridine N-oxide, N-nitroso-N-cyclohexyl hydroxylamine, 8-hydroxyquinoline, thiocarbamates and dithiocarbamates. The calcium, zinc, copper, and iron complexes of said biocides are generally characterized by water solubilities ranging from 0.05 mg/L to 10 g/L, or less than or equal to 1% by weight.

In another aspect, the present invention relates to a process for incorporating a metal salt or a complex of a biocide onto the surface or into the porous structure of a metal-containing molded plastic product. The method comprises contacting the molded plastic product with an aqueous solution of a water-soluble biocide in order to cause the water soluble biocide to react or chelate with at least a portion of the metal in the molded plastic product, thereby forming an antimicrobially protected molded plastic product having a water-insoluble metal salt of a biocide on a surface or in the porous structure thereof. Examples of water-soluble biocides forming insoluble metal salts and complexes are dipyrithione magnesium sulfate, sodium and potassium salts of pyrithione, 2-hydroxypyridine N-oxide, N-nitroso-N-cyclohexyl hydroxylamine, 8-hydroxyquinoline, thiocarbamates and dithiocarbamates. The calcium, zinc, copper, and iron complexes of said biocides are generally characterized by water solubilities ranging from 0.05 mg/L to 10 g/L, or less than or equal to 1% by weight.

These and other aspects will become apparent upon reading the following detailed description of the invention.

### DETAILED DESCRIPTION OF THE INVENTION

It has now been surprisingly found, in accordance with the present invention, that plastic products and plastic-forming compositions are suitably contacted with a water-soluble antimicrobial, such as sodium pyrithione, in an aqueous antimicrobial solution. The water-soluble antimicrobial is suitably converted to a water-insoluble antimicrobial (e.g., zinc pyrithione) by chelation with metal ions (e.g., zinc ions) present on an outside surface of, and/or in an interior porous portion of, the plastic product. The resulting water-insoluble metal salt (or complex) of the antimicrobial (e.g., zinc pyrithione) exhibits a slow release from the plastic product, thereby providing antimicrobial protection to the plastic material following extrusion or molding and during storage, distribution, and use. The resulting antimicrobial-containing plastic product is resistant to the growth of surface-defacing microorganisms, such as fungi, bacteria and algae, while enabling the use of relatively low levels of the antimicrobial component, preferably between 0.01 g/m² and 20 g/m² of active ingredient, based upon the surface area of the plastic product. This low usage level range provides a cost-effective antimicrobial treatment that eliminates the need to incorporate the antimicrobial throughout the plastic (so-called “bulk use” of the antimicrobial), and reduces the risk of undesired loss of antimicrobial to the environment that can occur when employing water-soluble antimicrobials to protect the plastics.

As used herein, the term “water-insoluble” is intended to designate biocides having a solubility in water the range of from about 0.05 milligrams to about 10 grams per liter, preferably from about 0.05 milligrams to about 1000 milligrams per liter, most preferably from about 0.05 milligrams to about 100 milligrams per liter. Illustrative water-insoluble biocides are zinc pyrithione (having a water solubility of 6 milligrams per liter) and copper pyrithione (having a water solubility of 0.1 milligram per liter. In contrast, “water-soluble” biocides have a higher water solubility. Illustratively, the water solubility of sodium pyrithione is 450 grams per liter.

The antimicrobial protection afforded by virtue of the present invention takes advantage of the fact that plastic-forming compositions, and plastic products typically contain metals that will react with, bind, or similarly chelate with water-soluble biocides such as pyrithione acid, sodium or potassium pyithione, dipyrithione magnesium sulfate, the acid form and the sodium or potassium salts of 2-hydroxypyridine N-oxide, N-nitroso-N-cyclohexyl hydroxylamine, 8-hydroxyquinoline, thiocarbamates and dithiocarbamates, and combinations thereof. The metal is sometimes incorporated into the plastics-forming composition by means of a filler and/or pigment, or by means of a functional additive, such as a lubricant, or by means of an inorganic biocide or re-enforcing agent. Alternatively, the metal may be present as part of a recycled plastic component. Typical metals include calcium, zinc, iron, copper, silver, titanium, manganese, and combinations thereof. These metals are typically present in or on the surface of the plastic as metal salts, such as stearates, laurates, borates, carbonates, silicates, chlorides, sulfates and combinations thereof. Alternatively, the metal can be present in elemental form, or as an oxide or hydroxide. Preferred metals are zinc and calcium, and illustrative salts include zinc stearate, zinc laurate, zinc oxide, zinc borate, zinc carbonate, calcium carbonate, calcium borate, iron oxide, copper oxide and combinations thereof, alone or in combination with other metal salts. Preferably the metal salt is present in the plastic forming composition, or plastic product, in an amount of from about 0.01% to about 20% or more based upon the weight of the plastic composition and at sufficient concentration to provide a surface metal concentration of from about 0.01 g/m² to about 20 g/m² or more.

The water-soluble biocide such as pyrithione, is suitably incorporated onto a surface of the plastic product, by conventional procedures such as spraying, dipping, drenching, impregnating, and the like.

If extrusion is used to fabricate the plastic product, then the extruded product is preferably dipped into a bath containing water-soluble biocide such as pyrithione, or a combination thereof with another water-soluble antimicrobial. Residence time of the extruded article in the bath is suitably between one and ten minutes, more or less. Lower residence times may require higher concentrations of biocide in the bath. Additional surface treatments that might be needed, such as combing or cutting of the plastic surface, are preferably conducted in the presence of the water-soluble biocide solution.

If molding is used to produce the plastic product, the plastic-forming composition is suitably contacted with the water-soluble biocide during or after the molding operation.

After the water-soluble biocide reacts or chelates with a suitable metal on the surface of the plastic, a metal salt of the biocide, such as zinc pyrithione, copper pyrithione, iron pyrithione, calcium pyrithione, silver pyrithione, titanium pyrithione, manganese pyrithione, zinc or copper hydroxyquinolate, zinc dimethyldithiocarbamate, copper N-nitroso-N-cyclohexyl hydroxylamine, or a combination thereof, is formed on an outer surface, or in the porous structure of the plastic product. Once incorporated into or onto the plastic product, the antimicrobial metal salt of the biocide protects the plastic product from microbial staining by a slow release of biocide following extrusion or molding, and during storage, distribution and use of the product.

The plastic forming composition suitably comprises a resin such as polyethylene (e.g., low density polyethylene (“LDPE”) or high density polyethylene (“HDPE”), polypropylene, polyallomer, polyacetal, polyamide, polyester, polystyrene, polycarbonate, polyurethane, acrylo-butadiene-styrene (“ABS”) polyvinylchloride, ethyl-vinyl acetate co-polymer, and combinations thereof. The plastic resin can be virgin resin, or recycled material, or a combination thereof. The total amount of resin preferably comprises between about 10% and about 90% based upon the total weight of the plastic-forming composition.

The plastic forming composition suitably contains optional additives, such as fillers. Suitable fillers include wood chips, wood fibers, wood flour, wood dust or other wood products. Other cellulosic material is suitably used as a filler, such as newspaper, rice hulls, straw, peanut shells, alfalfa, cotton, jute, and combinations thereof. Other optional components of the plastic-forming composition include re-enforcing additives, such as glass or carbon fibers. If used, the filler or re-enforcing agent is suitably employed in a total amount of from 10% to about 90% by weight based upon the total weight of the plastic-forming composition. Other additives, such as blowing agents, lubricants, heat stabilizers, waxes, talc, kickers, pigments, soaps, antioxidants, cross-linking agents, and combinations thereof are suitably employed as desired in a total amount of between about 0.1% and about 10% based upon the total weight of the plastic-forming composition.

Examples of lubricants include zinc stearate, calcium stearate and wax, and combinations thereof.. For extrusion of the plastic-forming composition, extrusion aids, such as accelerators, inhibitors, enhancers, compatibilizers, blowing agents, and combinations thereof, are suitably employed as desired.

The invention is further illustrated by the following Examples. Unless otherwise stated, the “parts” and “%” are “parts by weight” and “percent by weight”, respectively.

While the invention has been described above with references to specific embodiments thereof, it is apparent that many changes, modifications and variations can be made without departing from the inventive concept disclosed herein. Accordingly, it is intended to embrace all such changes, modifications and variations that fall within the spirit and broad scope of the appended claims. All patent applications, patents and other publications cited herein are incorporated by reference in their entirety.

The following examples are intended to illustrate, but in no way limit the scope of, the present invention.

### EXAMPLE 1

### Part A—Sample Preparation

A composite material containing oak flour, polyethylene resin, fillers, and 2.5% zinc stearate as lubricant was heated to extrusion temperature, then cooled in a cooling bath containing 2% sodium pyrithione for a period of two minutes. The article was removed from the treatment bath and rinsed with water to remove any unattached sodium pyrithione. After cooling completely at room temperature, the sample (Sample A) was dried to constant weight in a 65° C. oven, and submitted for microbiological challenge.

Sample B was prepared using the above methodology but employing a cooling bath containing 0.8% sodium pyrithione.

Sample C was prepared using the above methodology but employing a cooling bath containing 0.4% sodium pyrithione.

Sample D was prepared using the above methodology but employing a cooling bath containing 0.2% sodium pyrithione.

Sample E was prepared using the above methodology but employing a cooling bath containing water only and no sodium pyrithione.

Part B—Sample Testing using Microbial Challenges

Seven strains of fungi isolated from contaminated decking were sprayed on the above samples. The samples were incubated for four weeks and inspected at intervals for fungal growth. Sample E showed growth readily visible to the naked eye after 4 days' incubation. Samples B through D began to show traces of growth when inspected through a microscope after one week. Sample A showed growth when inspected under a microscope at week two, though no growth was visible to the naked eye. At the end of 4 weeks, Samples A through D were readily distinguished from control Sample E, with the latter showing heavy microbial growth.

### EXAMPLE 2

### Part A—Sample Preparation

Four composite materials containing oak flour, polyethylene resin, fillers, and 2.5% zinc stearate as lubricant were heated to extrusion temperatures. Two of the samples were cooled in a cooling bath containing 1.9% sodium pyrithione for a period of five minutes, while the remaining 2 samples were cooled in a bath containing 0.19% sodium pyrithione, also for a period of 5 minutes. The articles were removed from the treatment bath and rinsed with water to remove any unattached sodium pyrithione. After cooling completely at room temperature, the samples were dried to constant weight.

### Part B—Sample Characterization Using Surface Analysis and HPLC Analyses

The concentrations of sodium pyrithione in the 0.19% and 1.9% cooling baths were determined by HPLC analysis before and after contact with the composite materials. Surface incorporation of pyrithione was calculated by difference and divided by the surface area of the samples to give the surface coverage of zinc pyrithione in g/m².

| | Initial Bath | Final Bath | Surface |
|---|---|---|---|
| | NaPT Conc., | NaPT Conc., | coverage ZnPT |
| Trial | % | % | g/m² |
| 1 | 0.19 | 0.12 | 10.8 |
| 2 | 0.19 | 0.11 | 11.5 |
| 1 | 1.90 | 1.69 | 2.1 |
| 2 | 1.90 | 1.52 | 12.3 |

The dipped composite materials were additionally characterized by a surface analysis technique (ESCA) and compared to a control sample of the composite material which had not been dipped. Whereas no sulfur was detected on the surface of the control sample, ESCA demonstrated the presence of sulfur on the surface of the samples that had contacted the cooling baths. The pyrithione sulfur acts as a characteristic marker in this case and clearly demonstrates the incorporation of pyrithione onto the surface. Surface concentrations of zinc pyrithione were determined to be 1 to 2 weight percent by this method. This surface concentration is in the range provided by conventionally-formulated antimicrobial coatings which are typically about 0.1% to about 15% biocide, depending upon the field of application.

Surface Concentrations (weight %)

| | Undipped | 0.19% | 0.19% | 1.90% | 1.90% |
|---|---|---|---|---|---|
| | control | Trial 1 | Trial 2 | Trial 1 | Trial 2 |
| N | 1.2 | 2.8 | 3.7 | 3.2 | 2.5 |
| Zn | 2.5 | 1.0 | 1.0 | 1.0 | 1.0 |
| S | 0 | 0.25 | 0.5 | 0.25 | 0.5 |
| ZnPT | 0 | 1 | 2 | 1 | 2 |

What is claimed is:

1-16. (canceled)

17. An antimicrobially protected, metal-containing plastic structure produced by reacting or chelating at least a portion of said metal with a water-soluble biocide to form a water-insoluble metal salt of biocide on an outer surface of the article, or into a porous interior portion of the article, said water-insoluble metal salt of the biocide exhibiting a slow release rate of biocide from the surface or interior portion of the article, as compared to the release rate for the water-soluble biocide.

18. The plastic structure of claim 17 wherein the water-soluble biocide is selected from the group consisting of pyrithione, 2-hydroxypyridine N-oxide, N-nitroso-N-cyclohexyl hydroxylamine, 8-hydroxyquinoline, thiocarbamates, dithiocarbamates, and combinations thereof.

19. The plastic structure of claim 17 wherein the water-soluble biocide is a pyrithione selected from the group consisting of pyrithione acid, sodium pyrithione, potassium pyrithione, pyrithione disulfide magnesium sulfate, and combinations thereof.

20. The plastic structure of claim 17 wherein the metal is selected from the group consisting of calcium, zinc, iron, copper, silver, titanium, manganese, and combinations thereof.

21. The plastic structure of claim 17 wherein the metal is present as an oxide, hydroxide, carbonate, borate, silicate, chloride, sulfate, stearate, laurate, or combination thereof.

22. The plastic structure of claim 17 wherein the metal is present on the surface of the extruded or molded product, in an amount of from about 0.01 g/m² to about 20 g/m² or more, based upon the surface area of the extruded plastic.

23. The plastic structure of claim 17 wherein the metal is calcium, and the calcium is present on the surface of or in the porous structure of the extruded product, in an amount of from about 0.01 g/m² to 100 g/m² based upon the surface area of the extruded plastic.

24. The plastic structure of claim 17 wherein the metal is zinc, and the zinc is present on the surface of, or in the porous interior portion of the molded or extruded product, in an amount of from about 0.01 g/m² to about 20 g/m² based upon the surface area of the plastic structure.

25. The plastic structure of claim 17 where the water-insoluble metal biocide has a water solubility of 0.05 mg/L to 10 g/L of water.

26. The plastic structure of claim 17 wherein the water-insoluble metal biocide has a water solubility of 0.05 mg/L to 1000 mg/L of water.

27. The plastic structure of claim 17 wherein the water-insoluble metal biocide has a water solubility on the surface of the structure of from about 0.05 mg/L to 100 mg/L.

28. The plastic structure of claim 17 wherein the water-insoluble metal biocide has a surface concentration of about 0.01 g/m² to about 20 g/m².

29. The plastic structure of claim 17 wherein the plastic comprises a virgin or recycled resin suitable for extruding or molding such as polyethylene (e.g., low density polyethylene (“LDPE”) or high density polyethylene (“HDPE”), polypropylene, polyallomer, polyacetal, polyamide, polyester, polystyrene, polycarbonate, polyurethane, acrylonitrile-butadiene-styrene (“ABS”), polyvinylchloride, polyvinylfluoride, ethyl-vinyl acetate co-polymer, and combinations thereof.

30. The plastic structure of claim 17 which additionally contains at least one cellulosic filler selected from the group consisting of wood chips, wood fibers, wood flour, wood dust or the like, newspaper, rice hulls, straw, peanut shells, alfalfa, cotton, jute and combinations thereof.

31. The plastic structure of claim 17 wherein the plastic comprises a virgin or recycled resin suitable for molding selected from the group consisting of a polyester, a polyacrylate, and combinations thereof.

32. The plastic structure of claim 17 which additionally comprises reinforcing fibers selected from the group consisting of glass fibers, carbon fibers, polyester fibers, nylon and aramid fibers, cellulosic fibers and combinations thereof, and combinations thereof, thereby providing a reinforced plastic structure.
